(19) United States
(12) Patent Application Publication
(10) Pub. No.: US 2012/0177177 A1
(43) Pub. Date: Jul. 12, 2012

(54) Automated Non-Destructive Inspection System for Hard Armor Protective Inserts

(76) Inventor: Karl Masters, Culpeper, VA (US)

(21) Appl. No.: 11/781,620

(22) Filed: Oct. 17, 2007

(51) Int. Cl. G01N 23/04

(52) U.S. Cl. 378/58

(57) ABSTRACT

The Non-destructive Evaluation Automated Inspection System (NDE-AIS) is a deployable, high speed, automated, radiographic inspection system that determines ceramic plate serviceability in the field and has been designed, constructed and recently field tested. Ceramic plates are x-rayed and inspected at an average rate of 240 plates per hour in a process that automatically identifies and withdraws defective plates from service. Inspection results are maintained in a database which will help facilitate inventory, monitoring, logistical activities and production analysis. Ceramic armor plates are produced to meet a ballistic requirement. Because of this, each manufacturer has unique design attributes that are visible within an x-ray. The algorithm that supports the AIS accounts for these artifacts as well as others and has the ability to identify even the smallest of crack indications. All images are stored in a first in first out basis as a way to manually review the results of an image if needed. Currently the system can store well over 3000 images. UID labels created by a laser labeling system were placed on the plate and read by the UID reader on the AIS system. This label visibly shows the manufacturer, size, lot number, serial number and date of manufacturing. The reader captures all that data and uses it for material development and logistics.

To properly protect soldiers, the ceramic plate component in the Army's body armor must be free from cracks. This paper describes a deployable, high speed, automated, radiographic inspection system that determines ceramic plate serviceability in the field. Ceramic plates are inspected at an average rate of about 240 plates per hour in a process that automatically identifies and withdraws defective inserts from service. Inspection results are maintained in a database along with CAGE code, NSN and date of manufacturing information, which will help facilitate inventory, monitoring, logistical activities and production analysis. The mission, design, and effectiveness of the inspection device are discussed.

### 1. INTRODUCTION

Current designs of body armor within the Department of Defense normally incorporate ceramic tile and high performance fiber composite based hard inserts to provide rifle protection for an individual. Incorporated into the design are many features that make each design unique even though it may protect against the same threat level. However, most designs utilize a ceramic tile to provide superior ballistic performance at a light weight.

Hard armor inserts may be susceptible to failure if a crack is present in the ceramic. Although the ceramic is very hard, this characteristic also makes it brittle. Ceramic tiles are designed and manufactured to withstand certain loads and impacts, but even the toughest plate is susceptible to cracking. There can be several causes for this, but in most cases it is a result of mishandling or abusive use.

The Army currently uses a “torque test” in the field to evaluate hard armor plates. This is a process in which an individual grabs opposing corners of a plate and tries to twist the plate listening for crunching or cracking. When this test works, adjoining surfaces of a crack rub and create the sound that reveals the crack. Unfortunately, this easily-performed field test is not always reliable.

Non-destructive testing (NDT) methods tested for this application include radiography, ultrasonics, thermal imaging, and eddy current testing. Each method has advantages and disadvantages, and no single test method will detect every flaw. The “best” method optimizes performance with respect to the unique characteristics of the application. Digital radiography was ultimately chosen for this application because of (1) its capability to support high throughput, (2) its unique relative insensitivity to the considerable variations that exist in both the design and the condition of the insert covering, (3) its ability to detect at least some portion of the cracking in virtually every cracked plate, and (4) its ability to produce an understandable image record of inspected plates for verification purposes.

The Army has developed a Non-destructive Evaluation Automated Inspection System (NDE-AIS) that automatically identifies plates, evaluates and separates bad plates from good ones while maintaining a high throughput. It also has the capability to query data to provide logistical support and increase product quality. Project Manager Soldier Equipment, Technical Management Division developed this system with supporting efforts from JDLL, Inc. and the Ammunition Research Development and Evaluation Center (ARDEC).

### 2. DESCRIPTION OF THE NDE-AIS

### 2.1 Overview of the NDE-AIS

There are several subsystems that comprise the NDE-AIS. The first is the shell of the system which contains the Automated Inspection System and makes the system mobile. The whole system is contained within a Hard sided Expandable Light Air Mobile Shelter (HELAMS). The HELAMS has a detachable wheel set and can either be hauled or airlifted to a working location. It can sustain itself with a diesel generator, but it can also be connected to shore power. The HELAMS is climate controlled and creates a comfortable working environment for the user.

Within the HELAMS is the Automated Inspection System (AIS). The AIS consists of a conveyor, x-ray source, x-ray imager and computer with software required to analyze the plate images.

Another important feature supported by the AIS is the Unique Identifying Device (UID) reader. This feature allows the system to automatically detect the make of the plate, manufacturer, lot number, serial number and date of manufacturing. Not only does this allow the system to become fully automated, but it allows the user to query data for logistical reasons and identify if certain parameters within the plate are affecting its serviceability. The system's UID support enables the AIS to materially enhance the body armor quality and logistical control activities.

The NDE-AIS examines a plate every 15 seconds. The only interaction required of the user is loading and unloading the plates. Acceptable plates continue on the conveyor belt and can be offloaded on the opposite side of the machine by a second user. Defective plates are automatically identified and dropped into a different container to separate them from the serviceable plates.

### 2.2 Data Analysis

The AIS performs fully-automated acquisition and analysis of plates presented to the system. Analysis works by separating features expected in each x-ray image—those due to the ceramic plate, its backing, and cover—from features that reveal plate cracking. The algorithms that do this are designed so that the fraction of damaged plates mistakenly accepted can be traded against the fraction of undamaged plates that are rejected. The algorithm and the hardware on which it runs (a quartet of 64-bit AMD Opteron CPUs) are optimized to support AIS's four-plate-per-minute average throughput. Finally, to the extent feasible, the data analysis has been designed to accommodate plate design variations with minimal software adjustments.

The problem of removing expected projection features is complicated by their number and diversity. The algorithm accounts for artifacts due to radiographic and imager processes (such as exposure, varying x-ray field shape, plate-dependent x-ray scatter, and the imager's sensitivity field (its constant and time-varying components). It also accounts for a variety of plate sizes and designs, as well as plate-to-plate variations in fabrication technique that occur due to differences among factory personnel. Among the most challenging imaging artifacts is the fine local variation that arises as a combination of imager noise, photon noise, and as a result of the arrangement of fibers in the plate backing and cover. In many cases, crack indications are actually smaller than the level of interference imposed by these fine local variations, necessitating the use of algorithms related to the Hough transform. Our overall strategy, which accomplishes the above-described processing, is comprised of the following steps.
1. Remove artifacts of measurement
2. Remove expected structure
3. Minimize the effects of measurement noise
4. Identify and describe areas having related pixels
5. Remove noise areas
6. Remove any areas reflecting expected structure
7. Test remaining areas against criteria

Individual algorithm steps are controlled and tuned using parameters maintained in a system configuration file. These parameters can be used to improve system behavior as an increasingly large collection of plates with known results becomes available.

The x-ray equipment is composed of an x-ray source, which generates the x-rays and an imager which captures the x-ray image electronically. Because the behavior of the x-ray source and the imager can change over time, means are provided whereby these components can be calibrated. Calibration is fully automatic and is initiated by configuring a plate holder to present an empty field to the imager, Calibration is normally performed shortly after AIS startup on a daily basis.

### 2.3 Result Record-Keeping

As each plate enters the AIS imaging area its UID is read. UID data accompany the plate throughout the AIS inspection and are entered in fields in the AIS database. The UID is also used to construct the file name of the temporary result image that is maintained temporarily in a first-in-first-out (FIFO) method for possible use in offline auditing. In addition to the UID information, various system, plate, and evaluation parameters are stored in the tables of the AIS relational database. These parameters provide information useful for system maintenance, especially for subsequent logistical analysis.

### 3. PERFORMANCE EVALUATION

### 3.1 Demonstration Method

To validate the concept and levels of effective ceramic armor plate inspection of the NDE-AIS, a field demonstration was conducted using a control sample in January 2007.

This demonstration also helped validate the operations and throughput of the NDE-AIS. Over 2000 ceramic plates were inspected during this field demonstration.

The plates were grouped in four batches of approximately 500 plates. UID labels created by a laser labeling system were placed on the plate's lower right side to be read by the UID reader on the AIS system. Next, the plates were hand evaluated using the Army's “torque test”. Each ceramic plate's condition was noted and then placed on the conveyor to be evaluated by the NDE-AIS. In order to test the accuracy of the system, a blind manual review of each x-ray image in the NDE-AIS database was performed by a certified radiographer. Separately, a hardware check was conducted with 50 plates from each batch using a separate manual Vidisco x-ray system to ensure that the radiographic hardware within the AIS was capturing an accurate image.

### 3.2 Demonstration Results

The most critical value of the NDE-AIS is the false accept rate (plates which the NDE-AIS accepted but the radiographer found unserviceable). After the analysis, this was found to be the lowest percentage of the plates at 3% (64 plates). False rejects, which consist of plates the NDE-AIS rejected but the radiographer found serviceable, consisted of 10% of, the plates. This false reject rate represents the cost to the US Army with the disposal of possibly good plates. The true accept and reject percentage are green. The radiographer and NDE-AIS were in agreement a large majority of time (87%).

### 4. DISCUSSION

The NDE-AIS algorithm can be adjusted to appropriately balance rates of false acceptance and false rejection. These two rates are inversely related. If a lower false accept rate is desired, the false reject rate will increase. For example, opting for a decreased false acceptance rate favors Soldier safety at the expense of increased operation cost due to unnecessary plate rejection.

A key to reducing the amount of both parameters is to allow the system to “learn” the plate. This is done by allowing the NDE-AIS to become familiar with internal features normal to the production characteristics of the plate by analyzing a radiographic image of a good plate. This is an important part in keeping the performance of the NDE-AIS as accurate as possible. Because each design of each manufacturer must be programmed, part of the lifecycle management should be producing several plates of each type and size for the NDE-AIS to populate its plate library.

### 5. SUMMARY

This system will be an integral part of determining the life cycle management of the ballistic plate investment and critical to soldier survivability by facilitating logistical activities and production analysis. The NDE-AIS effectively evaluated a large volume of plates and was 97% effective in identifying unserviceable plates within the control sample. With minimal additional effort, improvements can be made to reduce the false acceptance and false reject rates further. The field demonstration was successful and showed that a fully automated system can accurately identify unserviceable plates at a rate of nearly 240 plates per hour negating the bias of human error.

1. The NDE-AIS is an automated system that uses a conveyor system to continuously move hard armor plates through a digital x-ray device to image the hard armor plate and uses algorithms to search for cracks within the image.

2. The NDE-AIS is fully automated and only requires a user to place plates on the conveyor and pull them off, not requiring a radiographer to study the image, and only relies upon the algorithms to decide the serviceability of the plate of which rejected plates are automatically segregated from good plates.

3. The NDE-AIS contains a UID reader which captures critical information of the plate like the manufacturer, lot number, serial number size of the plate and the date of manufacturing to use for logistical and research purposes.
